(19) United States
(12) Patent Application Publication
(10) Pub. No.: US 2010/0304726 A1
(43) Pub. Date: Dec. 2, 2010

(54) Method, device and system for implementing multimedia ring back tone

(75) Inventors: Hui Huang, Shenzhen (CN); Xioqing Hu, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/791,689

(22) Filed: Jun. 1, 2010

(30) Foreign Application Priority Data
May 31, 2009 (CN) 200910107563.X

(51) Int. Cl. H04W 4/00

(52) U.S. Cl. 455/414.3

(57) ABSTRACT

A method, device and system for implementing Multimedia Ring Back Tone (MRBT) are provided, where the method includes: when a multimedia terminal sends a multimedia call request to a non-multimedia terminal, receiving the multimedia call request forwarded by a Mobile Switching Center (MSC) according to subscription information for an MRBT service of the non-multimedia terminal acquired by a Home Location Register (HLR), wherein the multimedia call request includes a unique identifier of the non-multimedia terminal and/or a unique subscription identifier in the subscription information; and determining the non-multimedia terminal as a subscription terminal for the MRBT service according to a correspondence between the acquired unique identifier and the non-multimedia terminal or to the unique subscription identifier in the subscription information, and playing the MRBT to the multimedia terminal. Therefore, the calling multimedia terminal may not only communicate with the called non-multimedia terminal in voice, but also view other media information including videos.

### FIELD OF THE INVENTION

The present invention relates to the field of network communication, and particularly to a method, device and system for implementing multimedia ring back tone.

### BACKGROUND OF THE INVENTION

The ring back tone is a ring tone to be played by the communication system network to a calling terminal when the calling terminal calls a called terminal. When a calling terminal calls the called terminal, the calling terminal user will hear a ring back tone subscribed by the called terminal at the communication system network in advance if the called terminal is successfully paged and is ringing. The ring back tone may be music and songs which being pre-stored in the communication system network that provides the ring back tone service.

Since the Third Generation (3G) of Mobile Communication Network supports multimedia services, not only sounds, but also multimedia videos and audios can be used as ring back tones in the 3 G communication network.

### SUMMARY OF THE INVENTION

An embodiment of the present invention provides a method for implementing Multimedia Ring Back Tone (MRBT), including:

receiving a multimedia call request forwarded by a Mobile Switching Center (MSC) according to subscription information for an MRBT service of the non-multimedia terminal acquired by a Home Location Register (HLR) when a multimedia terminal sends a multimedia call request to a non-multimedia terminal, wherein the multimedia call request includes a unique identifier of the non-multimedia terminal and/or a unique subscription identifier in the subscription information; and

determining the non-multimedia terminal as a subscription terminal for the MRBT service according to a correspondence between the acquired unique identifier and the non-multimedia terminal or to the unique subscription identifier in the subscription information, and playing the MRBT to the multimedia terminal.

Another embodiment of the present invention provides an MRBT platform, including:

a call request receiving unit, configured to receive the multimedia call request forwarded by an MSC according to subscription information for a MRBT service of the non-multimedia terminal acquired by an HLR when a multimedia terminal sends a multimedia call request to a non-multimedia terminal, wherein the multimedia call request includes a unique identifier of the non-multimedia terminal and/or a unique subscription identifier in the subscription information;

a determining unit, configured to determine the non-multimedia terminal as a subscription terminal for the MRBT service according to a correspondence between the acquired unique identifier and the non-multimedia terminal or to the unique subscription identifier in the subscription information; and

a playing unit, configured to play the MRBT to the multimedia terminal according to a result of determination by the determining unit.

Another embodiment of the present invention provides an HLR, including:

a receiving unit, configured to receive a request for routing information of the non-multimedia terminal from the MSC when a multimedia terminal sends a multimedia call request to a non-multimedia terminal through an MSC;

a subscription information querying unit, configured to determine that the non-multimedia terminal subscribes for an MRBT service according to the request for routing information of the non-multimedia terminal; and

a responding unit, configured to return the subscription information for the MRBT service to the MSC, so that the MSC triggers the multimedia call request to an MRBT platform according to the subscription information for the MRBT service, wherein the multimedia call request includes a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

Another embodiment of the present invention provides an MSC, including:

a call request receiving unit, configured to receive a call request sent by a multimedia terminal to a non-multimedia terminal;

a sending unit, configured to send a request for routing information of the non-multimedia terminal to an HLR according to the call request;

a subscription information receiving unit, configured to receive subscription information for an MRBT service of the non-multimedia terminal returned by the HLR in response to the request for routing information of the non-multimedia terminal; and

a triggering unit, configured to trigger the multimedia call request to an MRBT platform according to the subscription information for the MRBT service, wherein the multimedia call request includes a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

Another embodiment of the present invention provides a system for implementing MRBT, including:

an MSC, configured to receive a call request sent by a multimedia terminal to a non-multimedia terminal, send a request for routing information of the non-multimedia terminal to an HLR according to the call request, receive subscription information for an MRBT service of the non-multimedia terminal returned by the HLR in response to the request for routing information of the non-multimedia terminal, and trigger the multimedia call request to an MRBT platform according to the subscription information for the MRBT service, wherein the multimedia call request includes a unique identifier of the non-multimedia terminal and/or a unique subscription identifier in the subscription information;

the HLR, configured to receive the request for routing information of the non-multimedia terminal from the MSC, determine that the non-multimedia terminal subscribes for an MRBT service according to the request for routing information of the non-multimedia terminal, and return the subscription information for the MRBT service to the MSC; and

the MRBT platform, configured to receive the multimedia call request, determine the non-multimedia terminal as a subscription terminal for the MRBT service according to a correspondence between the acquired unique identifier and the non-multimedia terminal or to the unique subscription identifier in the subscription information, and play the MRBT to the multimedia terminal.

According to the embodiments of the present invention, the non-multimedia terminal user may also subscribe for an MRBT service, so as to play an MRBT subscribed by the called non-multimedia terminal to the calling multimedia terminal during call connection, and thus the calling multimedia terminal user may receive the MRBT when the called party is the non-multimedia terminal user.

### BRIEF DESCRIPTION OF THE DRAWINGS

FIG. 1 is a system configuration diagram of a system for implementing MRBT according to an embodiment of the present invention;

FIG. 2 is a device configuration diagram of an MRBT platform according to an embodiment of the present invention;

FIG. 3 is a device configuration diagram of an HLR according to an embodiment of the present invention;

FIG. 4 is a device configuration diagram of an MSC according to an embodiment of the present invention;

FIG. 5 is a flowchart of a method for implementing MRBT according to an embodiment of the present invention;

FIG. 6 is a flowchart of a method for implementing MRBT according to an embodiment of the present invention;

FIG. 7 is a signaling diagram of a method for implementing MRBT according to an embodiment of the present invention; and

FIG. 8 is a signaling diagram of a method for implementing MRBT according to an embodiment of the present invention.

### DETAILED DESCRIPTION OF THE INVENTION

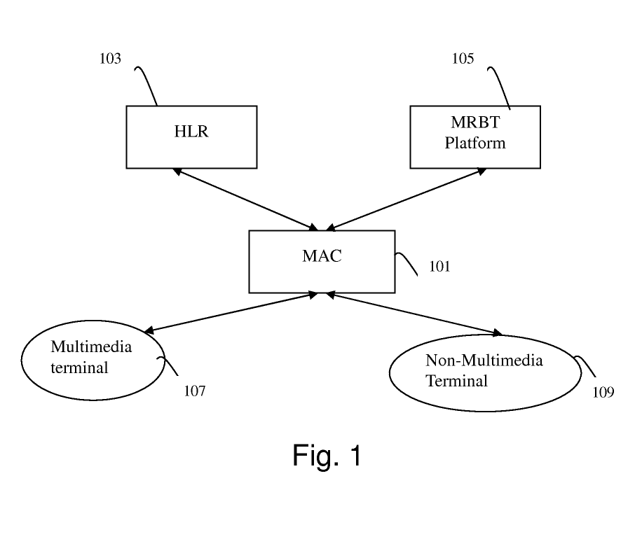

FIG. 1 is a system configuration diagram of a system for implementing MRBT according to an embodiment of the present invention. As shown in FIG. 1, the system includes an MSC 101, an HLR 103 and an MRBT platform 105.

The MSC 101 receives a call request sent by a multimedia terminal 107 to a non-multimedia terminal 109, sends a request for routing information of the non-multimedia terminal 109 to an HLR 103 according to the call request, receives subscription information for an MRBT service of the non-multimedia terminal 109 returned by the HLR 103 in response to the request for routing information of the non-multimedia terminal 109, and triggers the multimedia call request to an MRBT platform 105 according to the subscription information for the MRBT service, wherein the multimedia call request includes a unique identifier of the non-multimedia terminal 109 and/or a unique subscription identifier in the subscription information.

The HLR 103 receives the request for routing information of the non-multimedia terminal 109 from the MSC 101, determines that the non-multimedia terminal 109 subscribes for an MRBT service according to the request for routing information of the non-multimedia terminal, and returns the subscription information for the MRBT service to the MSC 101.

The MRBT platform 105 receives the multimedia call request, determines the non-multimedia terminal 109 as a subscription terminal for the MRBT service according to a correspondence between the acquired unique identifier and the non-multimedia terminal 109 or to the unique subscription identifier in the subscription information, and plays the MRBT to the multimedia terminal 107.

According to the embodiment of the present invention, the non-multimedia terminal user may also subscribe for an MRBT service, and during communication, the calling multimedia terminal may not only communicate with the called non-multimedia terminal in voice, but also view other media information including videos.

Optionally, the MRBT platform 105 specifically receives the multimedia call request, and determines the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal, or

determines the non-multimedia terminal as the subscription terminal for the MRBT service according to the unique subscription identifier in the subscription information when the multimedia call request includes the unique subscription identifier in the subscription information, or

determines the non-multimedia terminal 109 as the subscription terminal for the MRBT service according to the correspondence between the acquired unique identifier and the non-multimedia terminal 109 or to the unique subscription identifier in the subscription information when the multimedia call request includes the unique identifier of the non-multimedia terminal 109 and the unique subscription identifier in the subscription information, and send a voice call request to the non-multimedia terminal 109, receives an Address Complete Message (ACM) returned by the non-multimedia terminal 109, and plays the MRBT to the multimedia terminal according to the ACM.

Optionally, the MRBT platform 105 specifically receives a response message from the non-multimedia terminal 109, establishes a connection between the non-multimedia terminal 109 and the multimedia terminal 107 according to the response message, receives a multimedia data packet sent by the multimedia terminal 107, acquires audio data in the multimedia data packet, and sends the audio data to the non-multimedia terminal 109; receives audio data from the non-multimedia terminal 109, packs the audio data from the non-multimedia terminal 109 and the acquired multimedia data and sends the packed data to the multimedia terminal 107.

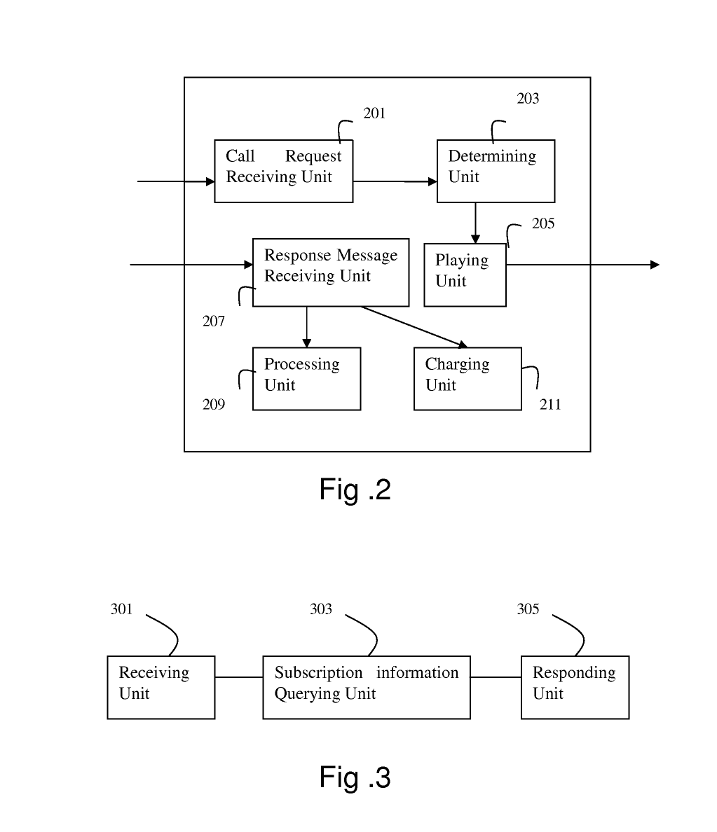

FIG. 2 is a device configuration diagram of an MRBT platform according to an embodiment of the present invention. As shown in FIG. 2, the MRBT platform includes a call request receiving unit 201, a determining unit 203 and a playing unit 205.

When a multimedia terminal sends a multimedia call request to a non-multimedia terminal, the call request receiving unit 201 receives the multimedia call request forwarded by an MSC according to subscription information for an MRBT service of the non-multimedia terminal acquired by an HLR, wherein the multimedia call request includes a unique identifier of the non-multimedia terminal and/or a unique subscription identifier in the subscription information.

The determining unit 203 determines the non-multimedia terminal as a subscription terminal for the MRBT service according to a correspondence between the acquired unique identifier and the non-multimedia terminal or to the unique subscription identifier in the subscription information.

The playing unit 205 plays the MRBT to the multimedia terminal according to a result of determination by the determining unit.

According to the embodiment of the present invention, the non-multimedia terminal user may also subscribe for an MRBT service, and during the communication, the calling multimedia terminal may not only communicate with the called non-multimedia terminal in voice, but also view other media information including videos.

Optionally, the determining unit 203 performs the operations of:

determining the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal, or

determining the non-multimedia terminal as the subscription terminal for the MRBT service according to the unique subscription identifier in the subscription information when the multimedia call request includes the unique subscription identifier in the subscription information; or

determining the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal and the unique subscription identifier in the subscription information.

Optionally, the playing unit 205 specifically sends a voice call request to the non-multimedia terminal, receives an ACM returned by the non-multimedia terminal, and plays the MRBT to the multimedia terminal according to the ACM.

Optionally, the playing unit 205 specifically performs a multimedia negotiation with the multimedia terminal, and after the negotiation is completed, plays the MRBT to the multimedia terminal.

Optionally, the MRBT platform may further include:

a response message receiving unit 207, configured to receive a response message from the non-multimedia terminal;

a processing unit 209, configured to establish a connection between the non-multimedia terminal and the multimedia terminal according to the response message, receive a multimedia data packet sent by the multimedia terminal, acquire audio data in the multimedia data packet, and send the audio data to the non-multimedia terminal; receive audio data from the non-multimedia terminal, pack the audio data from the non-multimedia terminal and the acquired multimedia data and send the packed data to the multimedia terminal; and

a charging unit 211, configured to initiate a charging process according to the response message.

FIG. 3 is a device configuration diagram of an HLR according to an embodiment of the present invention. As show in FIG. 3, the HLR includes a receiving unit 301, a subscription information querying unit 303 and a responding unit 305.

The receiving unit 301 receives a request for routing information of the non-multimedia terminal from the MSC when a multimedia terminal sends a multimedia call request to a non-multimedia terminal through an MSC.

The subscription information querying unit 303 determines that the non-multimedia terminal subscribes for an MRBT service according to the request for routing information of the non-multimedia terminal.

The responding unit 305 returns the subscription information for the MRBT service to the MSC, so that the MSC triggers the multimedia call request to an MRBT platform according to the subscription information for the MRBT service, wherein the multimedia call request includes a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

Optionally, the responding unit 305 specifically performs the operation of:

returning the subscription information for the MRBT service to the MSC, so that the MSC triggers the multimedia call request to the MRBT platform according to the subscription information for the MRBT service, wherein the multimedia call request includes the unique identifier of the non-multimedia terminal and/or the unique subscription identifier in the subscription information;

so that the MRBT platform determines the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal, and plays the MRBT to the multimedia terminal; or

the MRBT platform determines the non-multimedia terminal as the subscription terminal for the MRBT service according to the unique subscription identifier in the subscription information when the multimedia call request includes the unique subscription identifier in the subscription information, and plays the MRBT to the multimedia terminal; or

the MRBT platform determines the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal and the unique subscription identifier in the subscription information, and plays the MRBT to the multimedia terminal.

According to the embodiment of the present invention, the non-multimedia terminal user may also subscribe for an MRBT service, and then an MRBT subscribed by the called non-multimedia terminal is played to the calling multimedia terminal during call connection, so that the calling multimedia terminal user can receive the MRBT when the called party is the non-multimedia terminal user. In addition, during communication, the calling multimedia terminal may not only communicate with the called non-multimedia terminal in voice, but also view other media information including videos.

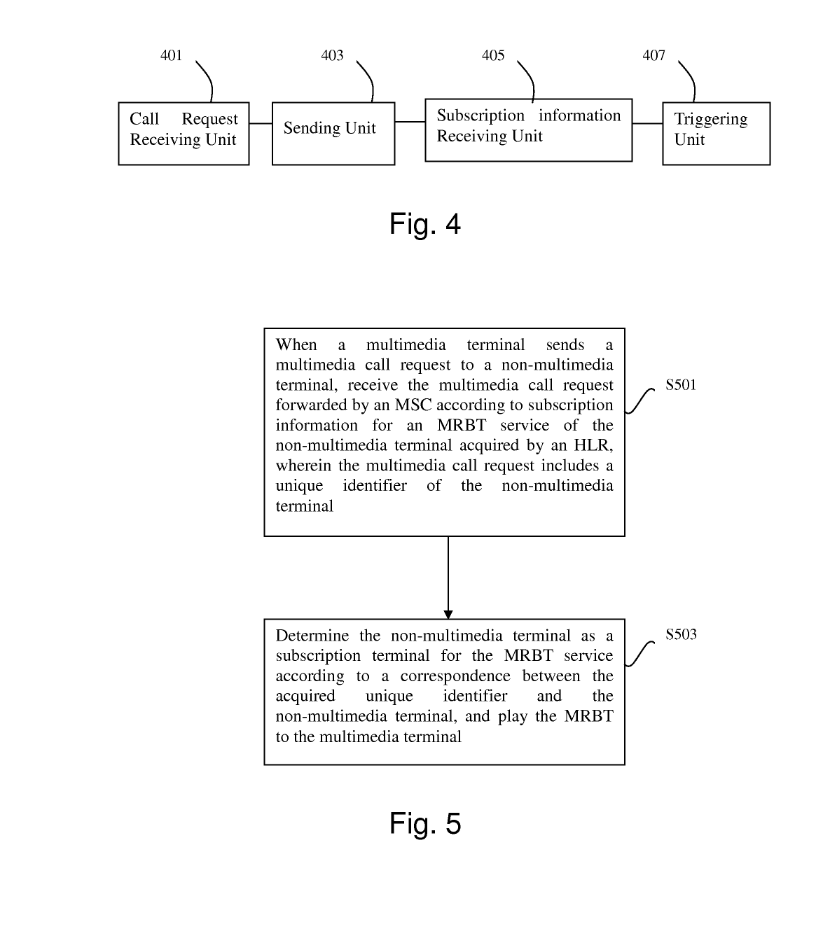

FIG. 4 is a device configuration diagram of an MSC according to an embodiment of the present invention. As shown in FIG. 4, the MSC includes a call request receiving unit 401, a sending unit 403, a subscription information receiving unit 405 and a triggering unit 407.

The call request receiving unit 401 receives a call request sent by a multimedia terminal to a non-multimedia terminal.

The sending unit 403 sends a request for routing information of the non-multimedia terminal to an HLR according to the call request.

The subscription information receiving unit 405 receives subscription information for an MRBT service of the non-multimedia terminal returned by the HLR in response to the request for routing information of the non-multimedia terminal.

The triggering unit 407 triggers the multimedia call request to an MRBT platform according to the subscription information for the MRBT service, wherein the multimedia call request includes a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

Optionally, the triggering unit 407 triggers the multimedia call request to the MRBT platform according to the subscription information for the MRBT service, wherein the multimedia call request includes the unique identifier of the non-multimedia terminal and/or the unique subscription identifier in the subscription information, so that the MRBT platform determines the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal, and plays the MRBT to the multimedia terminal; or

the MRBT platform determines the non-multimedia terminal as the subscription terminal for the MRBT service according to the unique subscription identifier in the subscription information when the multimedia call request includes the unique subscription identifier in the subscription information, and plays the MRBT to the multimedia terminal; or
the MRBT platform determines the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal and the unique subscription identifier in the subscription information, and plays the MRBT to the multimedia terminal.

According to the embodiment of the present invention, the non-multimedia terminal user may also subscribe for an MRBT service, and therefore, an MRBT subscribed by the called non-multimedia terminal may be played to the calling multimedia terminal during call connection, so that the calling multimedia terminal user can receive the MRBT when the called party is the non-multimedia terminal user. In addition, during communication, the calling multimedia terminal may not only communicate with the called non-multimedia terminal in voice, but also view other media information including videos.

FIG. 5 is a flowchart of a method for implementing MRBT according to an embodiment of the present invention. As shown in FIG. 5, the method includes the steps of:

S501: when a multimedia terminal sends a multimedia call request to a non-multimedia terminal, receiving the multimedia call request forwarded by an MSC according to subscription information for an MRBT service of the non-multimedia terminal acquired by an HLR, wherein the multimedia call request includes a unique identifier of the non-multimedia terminal and/or a unique subscription identifier in the subscription information; and
S503: determining the non-multimedia terminal as a subscription terminal for the MRBT service according to a correspondence between the acquired unique identifier and the non-multimedia terminal or to the unique subscription identifier in the subscription information, and playing the MRBT to the multimedia terminal.

According to the embodiment of the present invention, the non-multimedia terminal user may also subscribe for an MRBT service, and during communication, the calling multimedia terminal may not only communicate with the called non-multimedia terminal in voice, but also view other media information including videos.

Optionally, S503 may include:

determining the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal, and playing the MRBT to the multimedia terminal; or

determining the non-multimedia terminal as the subscription terminal for the MRBT service according to the unique subscription identifier in the subscription information when the multimedia call request includes the unique subscription identifier in the subscription information, and playing the MRBT to the multimedia terminal; or

determining the non-multimedia terminal as the subscription terminal for the MRBT service according to the correspondence between the acquired unique identifier and the non-multimedia terminal or to the unique subscription identifier in the subscription information when the multimedia call request includes the unique identifier of the non-multimedia terminal and the unique subscription identifier in the subscription information, and playing the MRBT to the multimedia terminal.

Optionally, in step S503, the process of playing the MRBT to the multimedia terminal further includes: sending a voice call request to the non-multimedia terminal, receiving an ACM returned by the non-multimedia terminal, and playing the MRBT to the multimedia terminal according to the ACM.

Optionally, in step S503, the process of playing the MRBT to the multimedia terminal further includes: negotiating with the multimedia terminal, and after the negotiation is completed, playing the MRBT to the multimedia terminal.

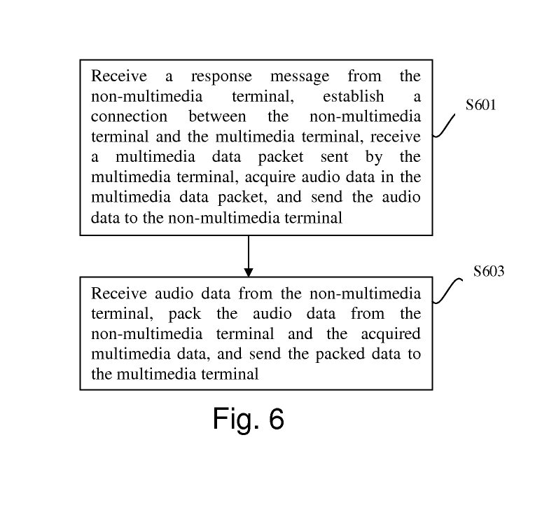

Optionally, as shown in FIG. 6, after step S503, the method may further include:

S601: receiving a response message from the non-multimedia terminal, establishing a connection between the non-multimedia terminal and the multimedia terminal, receiving a multimedia data packet sent by the multimedia terminal, acquiring audio data in the multimedia data packet, and sending the audio data to the non-multimedia terminal; and
S603: receiving audio data from the non-multimedia terminal, packing the audio data from the non-multimedia terminal and the acquired multimedia data, and sending the packed data to the multimedia terminal.

Herein, the multimedia data may be preset by the non-multimedia terminal or by a third party.

Optionally, after the step of receiving the response message from the non-multimedia terminal, the method may further include: instructing a charging device to initiate a charging process according to the response message.

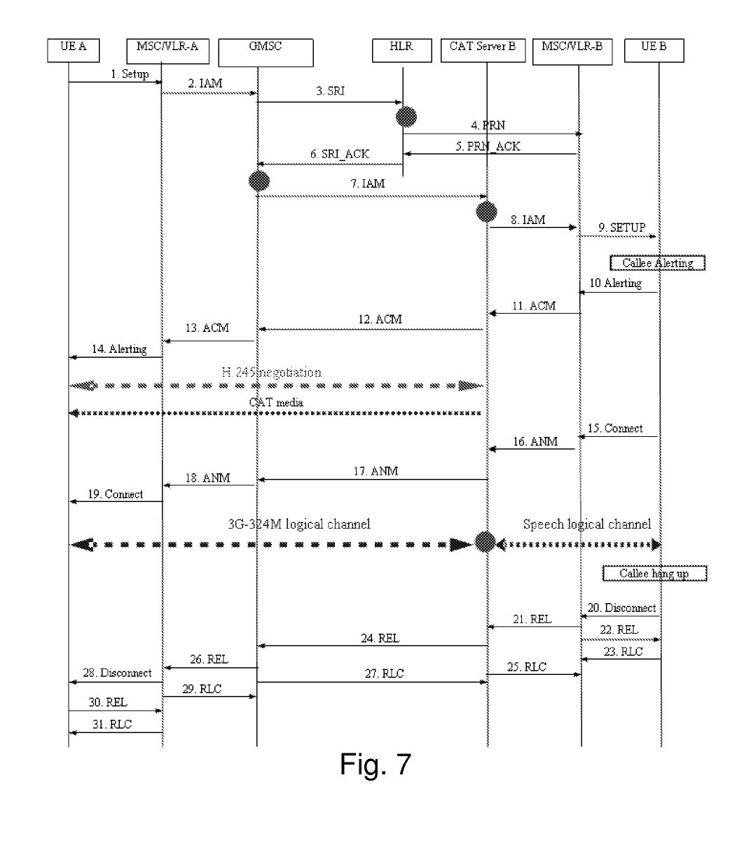

FIG. 7 is a signaling diagram of a method for implementing MRBT according to an embodiment of the present invention, including the following:

1. A multimedia terminal UE A initiates a multimedia call (e.g., a video call) to call the number of a non-multimedia terminal UE B, and sends a connection establishing message SETUP to a calling switch MSC-A.

2. The MSC-A sends an Initial Address Message (IAM) to a Gateway Mobile Switching Center (GMSC).

3. The GMSC sends a routing querying message SRI to an HLR to query routing information to the called terminal.

In this embodiment, the HLR does not return a failure message to the MSC just because the called terminal is a non-video non-multimedia terminal; instead, the HLR judges whether the non-multimedia terminal user subscribes for an MRBT service.

4. If an MRBT service is subscribed, the HLR sends a roaming number obtaining message PRN to a roaming MSC/visited location register VLR-B of the non-multimedia terminal, so as to obtain a roaming number.

5. The roaming MSC/VLR-B of the non-multimedia terminal returns the roaming number of the non-multimedia terminal to the HLR in a PRN acknowledgement message PRN_ACK.

6. The HLR sends the roaming number of the non-multimedia terminal and subscription information for an MRBT service of the non-multimedia terminal user to the GMSC in an SRI acknowledgement message SRI_ACK; the GMSC determines that the called non-multimedia terminal user is a user of the MRBT service according to the subscription information of the non-multimedia terminal, and the call path is bypassed to an MRBT platform CAT Server B for further processing.

7. The GMSC sends to the MRBT platform the IAM carrying a roaming number MSRN of the called non-multimedia terminal, a unique identifier (e.g., MSISDN) of the called non-multimedia terminal, and/or a unique subscription identifier in the subscription information;

the MRBT platform determines the non-multimedia terminal as the subscription terminal for the MRBT service according to the correspondence between the acquired unique identifier and the non-multimedia terminal or to the unique subscription identifier in the subscription information when the IAM includes the unique identifier of the non-multimedia terminal; or
the MRBT platform determines the non-multimedia terminal as the subscription terminal for the MRBT service according to the unique subscription identifier in the subscription information when the IAM includes the unique subscription identifier in the subscription information; or
the MRBT platform determines the non-multimedia terminal as the subscription terminal for the MRBT service according to the correspondence between the acquired unique identifier and the non-multimedia terminal or to the unique subscription identifier in the subscription information when the IAM includes the unique identifier of the non-multimedia terminal and the unique subscription identifier in the subscription information;
and then it is determined that a voice call is put through to the called non-multimedia terminal.

8. The MRBT platform sends the IAM to the roaming MSC-B of the called non-multimedia terminal.

9. The roaming MSC-B of the called non-multimedia terminal sends the SETUP message to the called non-multimedia terminal.

10. The called non-multimedia terminal returns a ringing message (e.g., Alerting), and rings at the called non-multimedia terminal at the same time.

11. The roaming MSC-B of the called non-multimedia terminal returns an ACM to the MRBT platform.

12. The MRBT platform sends the ACM to the GMSC.

13. The GMSC returns the ACM to the MSC-A.

14. The MSC-A returns an Alerting or Progress message to the calling multimedia terminal UE A to instruct the calling multimedia terminal to perform a multimedia (e.g., H.245) negotiation; the calling multimedia terminal UE A performs an H.245 negotiation with the MRBT platform, and after the negotiation is completed, the MRBT platform starts playing the MRBT to the calling multimedia terminal.

15. The called non-multimedia terminal responds to the call from the calling multimedia terminal, and sends a CONNECT message to the MSC-B.

16. The MSC-B sends an ANM to the MRBT platform; a voice channel is established between the called non-multimedia terminal and the MRBT platform.

17. The MRBT platform sends an acknowledgement message ANM to the GMSC.

18. The GMSC sends the ANM to the MSC-A to indicate that the called terminal has responded and the MSC-A starts charging.

19. The MSC-A sends the CONNECT message to the calling multimedia terminal UE A and the calling multimedia terminal UE A starts a communication timing;

the MRBT platform parses a multimedia format (e.g., 3G-324M) data packet from the calling multimedia terminal, and sends audio data therein to the called non-multimedia terminal, and thus the called non-multimedia terminal can hear the voice from the calling multimedia terminal; meanwhile, the MRBT platform packs audio data from the called non-multimedia terminal and a preset video stream in the 3G-324M standard, and sends the packed data to the calling multimedia terminal, so that the calling multimedia terminal can hear the voice from the called non-multimedia terminal and view a video at the same time, wherein the video may be a video in the MRBT subscribed by the called non-multimedia terminal, or a video set by the third party.

20. Assuming the called non-multimedia terminal hangs up firstly, and then the called non-multimedia terminal UE B sends a Disconnect message to the MSC-B.

21. The MSC-B sends a release request message REL to the MRBT platform.

22. The MSC-B sends a REL message to the called non-multimedia terminal UE B.

23. The called non-multimedia terminal UE B responds to the MSC-B with an RLC message.

24. The MRBT platform sends the REL message to the GMSC.

25. The MRBT platform responds to the MSC-B with an RLC message.

26. The GMSC sends a REL message to the MSC-A.

27. The GMSC responds to the MRBT platform with an RLC message.

28. The MSC-A sends a Disconnect message to the calling multimedia terminal UE A.

29. The MSC-A responds to the GMSC with an RLC message.

30. The calling multimedia terminal UE A sends a REL message to the MSC-A.

31. The MSC-A responds to the calling multimedia terminal UE A with an RLC message.

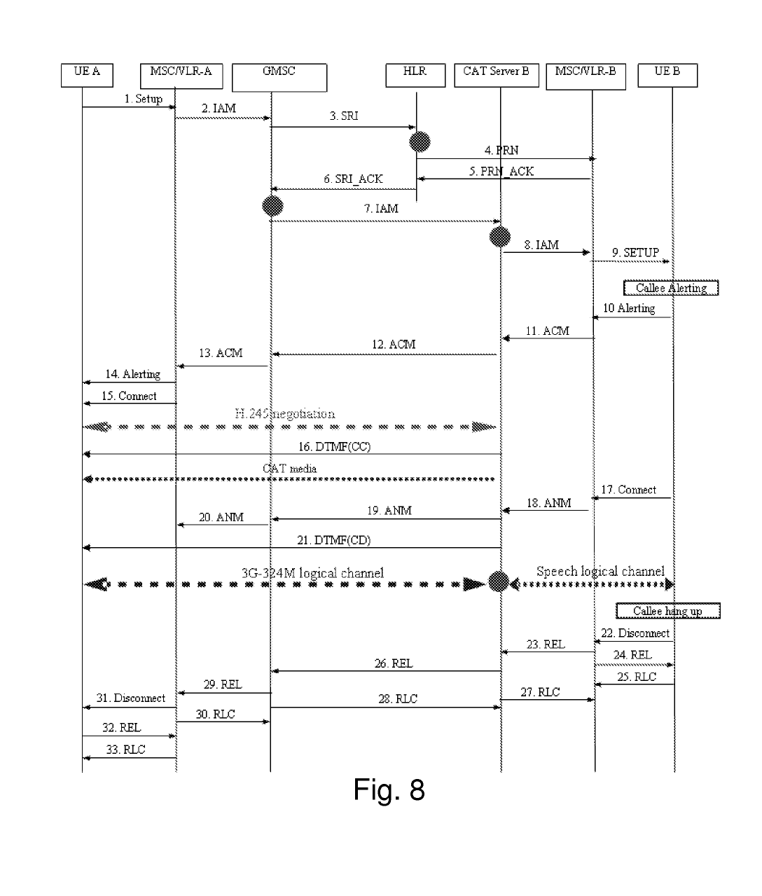

FIG. 8 is a signaling diagram of a method for implementing MRBT according to another embodiment of the present invention, including the following:

1. A multimedia terminal UE A initiates a multimedia call (e.g., a video call) to call the number of a non-multimedia terminal UE B, and sends a connection establishing message SETUP to a calling switch MSC-A.

2. The MSC-A sends an IAM to a GMSC.

3. The GMSC sends an SRI message to an HLR to query routing information of the called terminal;

in the embodiment, the HLR does not return a failure message to the MSC just because the called terminal is a non-video non-multimedia terminal; instead, the HLR judges whether the non-multimedia terminal user subscribes for an MRBT service.

4. If an MRBT service is subscribed, the HLR sends a PRN message to a roaming MSC/VLR-B of the called non-multimedia terminal, so as to acquire a roaming number.

5. The roaming MSC/VLR-B of the non-multimedia terminal returns the roaming number of the non-multimedia terminal to the HLR through a PRN_ACK message.

6. The HLR sends the roaming number of the non-multimedia terminal and subscription information for an MRBT service of the non-multimedia terminal user to the GMSC through an SRI acknowledgement message SRI_ACK;

the GMSC judges that the called non-multimedia terminal user is a user of the MRBT service according to the subscription information of the non-multimedia terminal, and the call path is bypassed to an MRBT platform CAT Server B for further processing.

7. The GMSC sends to the MRBT platform the IAM carrying the roaming number MSRN of the called non-multimedia terminal, a unique identifier (e.g., MSISDN) of the called non-multimedia terminal, and/or a unique subscription identifier in the subscription information;

the MRBT platform determines the non-multimedia terminal as the subscription terminal for the MRBT service according to the correspondence between the acquired unique identifier and the non-multimedia terminal or to the unique subscription identifier in the subscription information when the IAM includes the unique identifier of the non-multimedia terminal; or
the MRBT platform determines the non-multimedia terminal as the subscription terminal for the MRBT service according to the unique subscription identifier in the subscription information when the IAM includes the unique subscription identifier in the subscription information; or
the MRBT platform determines the non-multimedia terminal as the subscription terminal for the MRBT service according to the correspondence between the acquired unique identifier and the non-multimedia terminal or to the unique subscription identifier in the subscription information when the IAM includes the unique identifier of the non-multimedia terminal and the unique subscription identifier in the subscription information;
and then it is determined that a voice call is put through to the called non-multimedia terminal.

8. The MRBT platform sends the IAM to the roaming MSC-B of the called non-multimedia terminal.

9. The roaming MSC-B of the called non-multimedia terminal sends the SETUP message to the called non-multimedia terminal.

10. The called non-multimedia terminal returns a ringing message (e.g., Alerting), and rings at the called non-multimedia terminal at the same time.

11. The roaming MSC-B of the called non-multimedia terminal returns an ACM to the MRBT platform.

12. The MRBT platform sends the ACM to the GMSC.

13. The GMSC returns the ACM to the MSC-A.

14. The MSC-A sends an Alerting message to the calling multimedia terminal UE A.

15. The MSC-A sends a Connect message to the calling multimedia terminal UE A to instruct the calling multimedia terminal UE A to perform a multimedia (e.g., H.245) negotiation; the calling multimedia terminal UE A performs an H.245 negotiation with the MRBT platform.

16. After the H.245 negotiation is completed, the MRBT platform sends a Dual-Tone Multi-Frequency (DTMF) (CC) message to the calling multimedia terminal UE A to instruct the calling multimedia terminal UE A not to perform communication timing; then the MRBT platform starts playing the MRBT to the calling multimedia terminal UE A.

17. The called non-multimedia terminal responds to the call from the calling multimedia terminal and sends a CONNECT message to the MSC-B.

18. The MSC-B sends an ANM to the MRBT platform; a voice channel is established between the called non-multimedia terminal and the MRBT platform.

19. The MRBT platform sends an ANM to the GMSC.

20. The GMSC sends the ANM to the MSC-A to indicate that the called terminal has responded; the MSC-A starts charging.

21. The MRBT platform sends a DTMF (CD) message to the calling multimedia terminal UE A to instruct the calling multimedia terminal UE A to start timing the communication;

the MRBT platform parses a multimedia format (e.g., 3G-324M) data packet from the calling multimedia terminal, and sends audio data therein to the called non-multimedia terminal, so that the called non-multimedia terminal can hear the voice from the calling multimedia terminal; meanwhile, the MRBT platform packs audio data from the called non-multimedia terminal and a preset video stream in the 3G-324M standard, and sends the packed data to the calling multimedia terminal, so that the calling multimedia terminal can hear the voice form the called non-multimedia terminal and view a video at the same time, wherein the video may be a video in the MRBT subscribed by the called non-multimedia terminal, or a video set by the third party.

22. Assuming the called non-multimedia terminal hangs up firstly, and then the called non-multimedia terminal UE B sends a Disconnect message to the MSC-B.

23. The MSC-B sends a REL message to the MRBT platform.

24. The MSC-B sends a REL message to the called non-multimedia terminal UE B.

25. The called non-multimedia terminal UE B responds to the MSC-B with an RLC message.

26. The MRBT platform sends a REL message to the GMSC.

27. The MRBT platform responds to the MSC-B with an RLC message.

28. The GMSC sends the REL message to the MSC-A.

29. The GMSC responds to the MRBT platform with an RLC message.

30. The MSC-A sends a Disconnect message to the calling multimedia terminal UE A.

31. The MSC-A responds to the GMSC with an RLC message.

32. The calling multimedia terminal UE A sends a REL message to the MSC-A.

33. The MSC-A responds to the calling multimedia terminal UE A with an RLC message.

According to the embodiments of the present invention, the non-multimedia terminal user may also subscribe for an MRBT service, and therefore, an MRBT subscribed by the called non-multimedia terminal is played to the calling multimedia terminal during call connection, so that the calling multimedia terminal user can receive the MRBT when the called party is the non-multimedia terminal user. In addition, during communication, the calling multimedia terminal may not only communicate with the called non-multimedia terminal in voice, but also view other media information including videos.

In the above embodiments of the present invention, the non-multimedia terminal may be a non-video terminal such as a voice terminal.

It will be appreciated by a person skilled in the art that all or a part of the steps for implementing the above method embodiments can be carried out by a program instructing relevant hardware. The program can be stored in a computer readable storage medium, and when the program is executed, the steps for implementing the above method embodiments are carried out. The storage medium may include various mediums that can store program codes such as a ROM, a RAM, a magnetic disk or an optical disk.

It is apparent to a person skilled in the art that various changes and variations may be made to the present invention without deviating from the spirit and scope thereof. Thus, the present invention is also intended to include these changes and variations as long as they fall within the scope of the claims and their equivalents.

What is claimed is:

1. A method for implementing Multimedia Ring Back Tone (MRBT), comprising:
receiving the multimedia call request forwarded by a Mobile Switching Center (MSC) according to subscription information for an MRBT service of the non-multimedia terminal acquired by a Home Location Register (HLR) when a multimedia terminal sends a multimedia call request to a non-multimedia terminal, wherein the multimedia call request comprises a unique identifier of the non-multimedia terminal and/or a unique subscription identifier in the subscription information; and
determining the non-multimedia terminal as a subscription terminal for the MRBT service according to a correspondence between the acquired unique identifier and the non-multimedia terminal or to the unique subscription identifier in the subscription information, and playing the MRBT to the multimedia terminal.

2. The method for implementing MRBT according to claim 1, wherein the step of determining the non-multimedia terminal as the subscription terminal for the MRBT service according to the correspondence between the acquired unique identifier and the non-multimedia terminal or to the unique subscription identifier in the subscription information, and playing the MRBT to the multimedia terminal comprises:
determining the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal, and playing the MRBT to the multimedia terminal; or
determining the non-multimedia terminal as the subscription terminal for the MRBT service according to the unique subscription identifier in the subscription information when the multimedia call request comprises the unique subscription identifier in the subscription information, and playing the MRBT to the multimedia terminal; or
determining the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal and the unique subscription identifier in the subscription information, and playing the MRBT to the multimedia terminal.

3. The method for implementing MRBT according to claim 1, wherein the step of playing the MRBT to the multimedia terminal comprises:
sending a voice call request to the non-multimedia terminal, receiving an Address Complete Message (ACM) returned by the non-multimedia terminal, and playing the MRBT to the multimedia terminal according to the ACM.

4. The method for implementing MRBT according to claim 3, wherein after the step of playing the MRBT to the multimedia terminal, the method further comprises:
receiving a response message from the non-multimedia terminal, establishing a connection between the non-multimedia terminal and the multimedia terminal, receiving a multimedia data packet sent by the multimedia terminal, acquiring audio data in the multimedia data packet, and sending the audio data to the non-multimedia terminal; and
receiving audio data from the non-multimedia terminal, packing the audio data from the non-multimedia terminal and the acquired multimedia data, and sending the packed data to the multimedia terminal.

5. A Multimedia Ring Back Tone (MRBT) platform, comprising:
a call request receiving unit, configured to receive the multimedia call request forwarded by a Mobile Switching Center (MSC) according to subscription information for an MRBT service of the non-multimedia terminal acquired by a Home Location Register (HLR) when a multimedia terminal sends a multimedia call request to a non-multimedia terminal, wherein the multimedia call request comprises a unique identifier of the non-multimedia terminal and/or a unique subscription identifier in the subscription information;
a determining unit, configured to determine the non-multimedia terminal as a subscription terminal for the MRBT service according to a correspondence between the acquired unique identifier and the non-multimedia terminal or to the unique subscription identifier in the subscription information; and
a playing unit, configured to play the MRBT to the multimedia terminal according to a result of determination by the determining unit.

6. The MRBT platform according to claim 5, wherein the determining unit is further configured to:
determine the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal; or
determine the non-multimedia terminal as the subscription terminal for the MRBT service according to the unique subscription identifier in the subscription information when the multimedia call request comprises the unique subscription identifier in the subscription information; or
determine the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal and the unique subscription identifier in the subscription information.

7. The MRBT platform according to claim 5, wherein the playing unit is further configured to send a voice call request to the non-multimedia terminal, receive an Address Complete Message (ACM) returned by the non-multimedia terminal, and play the MRBT to the multimedia terminal according to the ACM.

8. The MRBT platform according to claim 7, further comprising:
a response message receiving unit, configured to receive a response message from the non-multimedia terminal; and
a processing unit, configured to establish a connection between the non-multimedia terminal and the multimedia terminal according to the response message, receive a multimedia data packet sent by the multimedia terminal, acquire audio data in the multimedia data packet, and send the audio data to the non-multimedia terminal; and receive audio data from the non-multimedia terminal, pack the audio data from the non-multimedia terminal and the acquired multimedia data and send the packed data to the multimedia terminal.

9. A Home Location Register (HLR), comprising:
a receiving unit, configured to receive a request for routing information of the non-multimedia terminal from the MSC when a multimedia terminal sends a multimedia call request to a non-multimedia terminal through a Mobile Switching Center (MSC);
a subscription information querying unit, configured to determine that the non-multimedia terminal subscribes a Multimedia Ring Back Tone (MRBT) service according to the request for routing information of the non-multimedia terminal; and
a responding unit, configured to return the subscription information for the MRBT service to the MSC, so that the MSC triggers the multimedia call request to an MRBT platform according to the subscription information for the MRBT service, wherein the multimedia call request comprises a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

10. The HLR according to claim 9, wherein the responding unit is further configured to return the subscription information for the MRBT service to the MSC, so that the MSC triggers the multimedia call request to the MRBT platform according to the subscription information for the MRBT service, wherein the multimedia call request comprises the unique identifier of the non-multimedia terminal and/or the unique subscription identifier in the subscription information, so that the MRBT platform determines the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal, and plays the MRBT to the multimedia terminal; or
that the MRBT platform determines the non-multimedia terminal as the subscription terminal for the MRBT service according to the unique subscription identifier in the subscription information when the multimedia call request comprises the unique subscription identifier in the subscription information, and plays the MRBT to the multimedia terminal; or
that the MRBT platform determines the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal and the unique subscription identifier in the subscription information, and plays the MRBT to the multimedia terminal.

11. A Mobile Switching Center (MSC), comprising:
a call request receiving unit, configured to receive a call request sent by a multimedia terminal to a non-multimedia terminal;
a sending unit, configured to send a request for routing information of the non-multimedia terminal to a Home Location Register (HLR) according to the call request;
a subscription information receiving unit, configured to receive subscription information for a Mobile Ring Back Tone (MRBT) service of the non-multimedia terminal returned by the HLR in response to the request for routing information of the non-multimedia terminal; and
a triggering unit, configured to trigger the multimedia call request to an MRBT platform according to the subscription information for the MRBT service, wherein the multimedia call request comprises a unique identifier of the non-multimedia terminal and/or a unique subscription identifier in the subscription information, so that the MRBT platform determines the non-multimedia terminal as a subscription terminal for the MRBT service according to a correspondence between the acquired unique identifier and the non-multimedia terminal or to the unique subscription identifier in the subscription information, and plays the MRBT to the multimedia terminal.

12. The MSC according to claim 11, wherein the triggering unit is further configured to trigger the multimedia call request to the MRBT platform according to the subscription information for the MRBT service, and wherein the multimedia call request comprises the unique identifier of the non-multimedia terminal and/or the unique subscription identifier in the subscription information, so that the MRBT platform determines the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal, and plays the MRBT to the multimedia terminal; or
that the MRBT platform determines the non-multimedia terminal as the subscription terminal for the MRBT service according to the unique subscription identifier in the subscription information when the multimedia call request comprises the unique subscription identifier in the subscription information, and plays the MRBT to the multimedia terminal; or
that the MRBT platform determines the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal and the unique subscription identifier in the subscription information, and plays the MRBT to the multimedia terminal.

13. A system for implementing Multimedia Ring Back Tone (MRBT), comprising:
a Mobile Switching Center (MSC) configured to receive a call request sent by a multimedia terminal to a non-multimedia terminal, send a request for routing information of the non-multimedia terminal to a Home Location Register (HLR) according to the call request, receive subscription information for an MRBT service of the non-multimedia terminal returned by the HLR in response to the request for routing information of the non-multimedia terminal, and trigger the multimedia call request to an MRBT platform according to the subscription information for the MRBT service, wherein the multimedia call request comprises a unique identifier of the non-multimedia terminal and/or a unique subscription identifier in the subscription information;
the HLR configured to receive the request for routing information of the non-multimedia terminal from the MSC, determine that the non-multimedia terminal subscribes for an MRBT service according to the request for routing information of the non-multimedia terminal, and return the subscription information for the MRBT service to the MSC; and
the MRBT platform configured to receive the multimedia call request, determine the non-multimedia terminal as a subscription terminal for the MRBT service according to a correspondence between the acquired unique identifier and the non-multimedia terminal or to the unique subscription identifier in the subscription information, and play the MRBT to the multimedia terminal.

14. The system for implementing MRBT according to claim 13, wherein the MRBT platform is further configured to receive the multimedia call request, and
determine the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal; or
determine the non-multimedia terminal as the subscription terminal for the MRBT service according to the unique subscription identifier in the subscription information when the multimedia call request comprises the unique subscription identifier in the subscription information; or
determine the non-multimedia terminal as the subscription terminal for the MRBT service according to the correspondence between the acquired unique identifier and the non-multimedia terminal or to the unique subscription identifier in the subscription information when the multimedia call request comprises the unique identifier of the non-multimedia terminal and the unique subscription identifier in the subscription information; and
send a voice call request to the non-multimedia terminal, receive an Address Complete Message (ACM) returned by the non-multimedia terminal, and play the MRBT to the multimedia terminal according to the ACM.

15. The system for implementing MRBT according to claim 14, wherein the MRBT platform is further configured to receive a response message from the non-multimedia terminal, establish a connection between the non-multimedia terminal and the multimedia terminal according to the response message, receive a multimedia data packet sent by the multimedia terminal, acquire audio data in the multimedia data packet, and send the audio data to the non-multimedia terminal; and receive audio data from the non-multimedia terminal, pack the audio data from the non-multimedia terminal and the acquired multimedia data and send the packed data to the multimedia terminal.
